(19) United States
(12) Patent Application Publication
(10) Pub. No.: US 2003/0060206 A1
(43) Pub. Date: Mar. 27, 2003

(54) Method and apparatus for avoiding mutual interference when co-locating mobile station and bluetooth systems

(76) Inventors: Erkka Sointula, San Diego, CA (US); Lanh Trinh, Carlsbad, CA (US)

Correspondence Address: HARRINGTON & SMITH, LLP, 4 RESEARCH DRIVE, SHELTON, CT, 06484-6212, US

(21) Appl. No.: 09/966,466

(22) Filed: Sep. 27, 2001

(51) Int. Cl. H04Q 7/20

(52) U.S. Cl. 455/450; 455/452

(57) ABSTRACT

A communication system includes a mobile station (100) having a transmitter (210) operating on one of a plurality of frequency channels in a first RF frequency band; an associated local area communication subsystem (304) operating by frequency hopping amongst a plurality of channels in a second RF frequency band and a controller (120) that operates in one embodiment for altering a frequency hopping pattern of the local area subsystem as a function of a currently specified frequency channel in the first frequency band. The frequency hopping pattern is preferably also altered as a function of a bandwidth of the currently specified frequency channel of the mobile station. The frequency hopping pattern is altered if the currently specified frequency channel is one having a harmonic frequency that lies in the second frequency band. Preferably, the first frequency band is in the range of about 800 MHz to about 900 MHz , the second frequency band is in the range of about 2400 MHz to about 2500 MHz, and the bandwidth is in the range of about 30 kHz to about 5 MHz. In another embodiment transmission of data is instead inhibited on one or more specified hopped-to frequency channels to avoid interference from the mobile station transmitter.

### TECHNICAL FIELD

These teachings relate generally to wireless communications devices and systems and, more specifically relate to the simultaneous use of two wireless transceivers and the mitigation of co-interference.

### BACKGROUND

As cellular telephones and other types of wireless personal communication devices evolve there is and will be a tendency to provide additional capabilities by including a separate low power RF communication subsystem for enabling the local control of peripheral devices and the transfer of data between the local peripherals and the communication device. Such peripherals may include headsets, printers, portable computers and the like. One emerging technology for providing this enhanced capability is known as Bluetooth.

In the Bluetooth model a protocol stack includes a radio layer at the bottom which forms a physical connection interface. A Baseband layer and a Link Manager Protocol (LMP) layer reside over the Radio layer for establishing control links between Bluetooth devices. These three bottom layers are typically implemented in hardware/firmware. A Host Controller layer is provided to interface the Bluetooth hardware to an upper protocol-L2CAP(Logical Link Control and Adaptation Protocol). The Host Controller layer is normally required only when the L2CAP resides in software in the host. If the L2CAP is also on the Bluetooth module, this layer may not be required as the L2CAP can directly communicate with the LMP and baseband layers. One or more applications reside above L2CAP layer. Of most interest to the teachings herein are the lower-most layers, including the Baseband and Radio layers or levels.

The Radio layer provides a wireless (RF) link that operates in the unlicensed ISM band around 2.4 GHz using spread spectrum communication techniques. The band extends from 2400 MHz to 2483.5 MHz in most countries, and this entire spectrum range is utilized for optimizing spectrum spreading. A frequency hopping technique is used to provide the spread spectrum function. As multiple uncoordinated networks may exist in this band and may cause interference, fast frequency hopping and short data packets are used. The error rate may be high, especially due to strong interference from microwave ovens which operate at this frequency. CVSD coding has been adopted for voice communication, which can withstand high bit error rates. In addition, the packet headers are protected by a highly redundant error correction scheme to make them robust to errors.

The frequency hops are fixed at 2402+k MHz, where k=0, 1, . . . , 78. The nominal hop rate is 1600 hops per second, yielding a single hop slot width or time of 625 microseconds. The modulation used is Gaussian prefiltered Binary FSK, and the Gaussian filter has BT=0.5. The transmitter power is fixed at 0 dBm for a 10 m range, and can be increased to 20 dBm for a 100 m range.

The Baseband layer is the layer that controls the Radio layer. The frequency hop sequences (pseudorandom) are provided by the Baseband layer. The Baseband layer also performs lower level encryption for secure links, and is responsible for packet handling over the wireless link.

Two types of links can be established. These are Synchronous Connection Oriented (SCO) links intended for synchronous data, typically voice, and Asynchronous Connectionless (ASO) links used for data transfer applications that do not require a synchronous link.

The Baseband layer further provides the functionalities required for devices to synchronize their clocks and establish connections. Inquiry procedures for discovering the addresses of devices in proximity are also provided. Error correction for packets is provided depending on the type of packet. Various packet types are specified for some common applications, differing in their data capacity and error correction overheads. Five different channel types are provided: control information, link management information, user synchronous data, user asynchronous data and isosynchronous data. Data whitening is also carried out at the Baseband layer.

The inventors have determined that the Bluetooth system is potentially susceptible to another type of interference, specifically one that originates from the operation of an associated cellular telephone, in particular those cellular telephones that operate in the 824 MHz to 891 MHz frequency band. More specifically, when the cellular telephone and the Bluetooth module operate simultaneously on the same platform, harmonic and possibly spurious signals generated by the cellular telephone transmitter can interfere with the reception of the Bluetooth system. In particular, the 3^{rd} harmonic of the transmit signal of an Advanced Mobile Phone Service (AMPS, EIA-553) or a Code Division Multiple Access (CDMA, e.g., one based on IS-95 and later versions) or a Time Division Multiple Access (TDMA, e.g., one based on IS-54 and later versions) at least partially overlaps the ISM band where the Bluetooth devices operate. Since these harmonics are typically at a much higher level than the Bluetooth devices' receive sensitivity, the link quality of the Bluetooth system can be impaired. This is obviously an undesirable situation.

### SUMMARY OF THE PREFERRED EMBODIMENTS

The foregoing and other problems are overcome, and other advantages are realized, in accordance with the presently preferred embodiments of these teachings.

A communication system is disclosed that includes a mobile station having a transmitter operating on one of a plurality of frequency channels in a first RF frequency band; an associated local area subsystem operating by frequency hopping amongst a plurality of channels in a second RF frequency band and a controller for altering a frequency hopping pattern of the local area subsystem as a function of a currently specified frequency channel in the first frequency band. In this embodiment the frequency hopping pattern is preferably also altered as a function of a bandwidth of the currently specified frequency channel of the mobile station. The frequency hopping pattern is altered if the currently specified frequency channel is one having a known frequency that lies in the second frequency band, more specifically if a frequency to be hopped-to is one that corresponds to a harmonic frequency of the currently specified frequency channel and has the potential to be interfered with by the harmonic frequency of the mobile station transmitter.

In one embodiment the frequency hopping pattern is altered by excluding at least one of the plurality of channels if the bandwidth is about 30 kHz, and excluding more than one of the plurality of channels if the bandwidth is about 5 MHz. The frequency hopping pattern may also be altered by selecting another channel if an excluded at least one of the plurality of channels is selected to be hopped to.

In a further embodiment a communication system is disclosed that includes the mobile station having the transmitter operating on one of the plurality of frequency channels in the first RF frequency band and the associated local area subsystem operating by frequency hopping amongst a plurality of channels in the second RF frequency band. In this embodiment the controller does not alter the frequency hopping pattern of the local area subsystem, but instead inhibits transmission of data in the local area subsystem when a hopped-to frequency is determined to be a frequency that may be interfered with because of operation of the mobile station transmitter on the currently specified frequency channel in the first frequency band. In this embodiment the transmission is preferably selectively inhibited as a function of a bandwidth of the currently specified frequency channel of the mobile station. The transmission in the local area subsystem is inhibited if the currently specified frequency channel is one having a harmonic frequency that lies in the second frequency band, more specifically if the hopped-to frequency is one that corresponds to the harmonic frequency and has the potential to be interfered with by the harmonic frequency of the mobile station transmitter.

In this latter embodiment the transmission of data in the local area subsystem may be inhibited by turning off a modulator during the slot time of the hopped-to frequency channel, thereby not transmitting data, or the transmission may be inhibited by turning off the RF carrier during the slot time of the hopped-to frequency channel, thereby also not transmitting data. The transmission of data may also be inhibited by simply transmitting random bits, or some predetermined pattern of bits, instead of the actual data to be transmitted. At the end of the slot time of the hopped-to frequency channel, and when hopping to a next channel (assuming that the next channel is not also potentially interfered with), the transmission of data is resumed, such as by once more turning on the modulator or the RF carrier, and data transmission to the local area subsystem receiver of the mobile station is resumed.

Preferably, the first frequency band is in the range of about 800 MHz to about 900 MHz and the second frequency band is in the range of about 2400 MHz to about 2500 MHz. The bandwidth may be in the range of about 30 kHz to about 5 MHz. More preferably, the first frequency band is in the range of about 824 MHz to about 891 MHz and the frequency hops occur at 2402+k MHz, where k=0, 1, . . . , 78.

An advantage of the use of these teachings is that required re-transmissions of data in the local area communications system, due to interference from the mobile station transmitter, may be reduced or eliminated.

### DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a block diagram of a wireless communication system in accordance with these teachings;

FIG. 2 is a diagram showing a selected frequency channel, its harmonics, and the potential interference in the ISM band;

FIG. 3 is a logic flow diagram in accordance with a first method of this invention; and

FIG. 4 is a logic flow diagram in accordance with a second method of this invention.

### DETAILED DESCRIPTION OF THE PREFERRED EMBODIMENTS

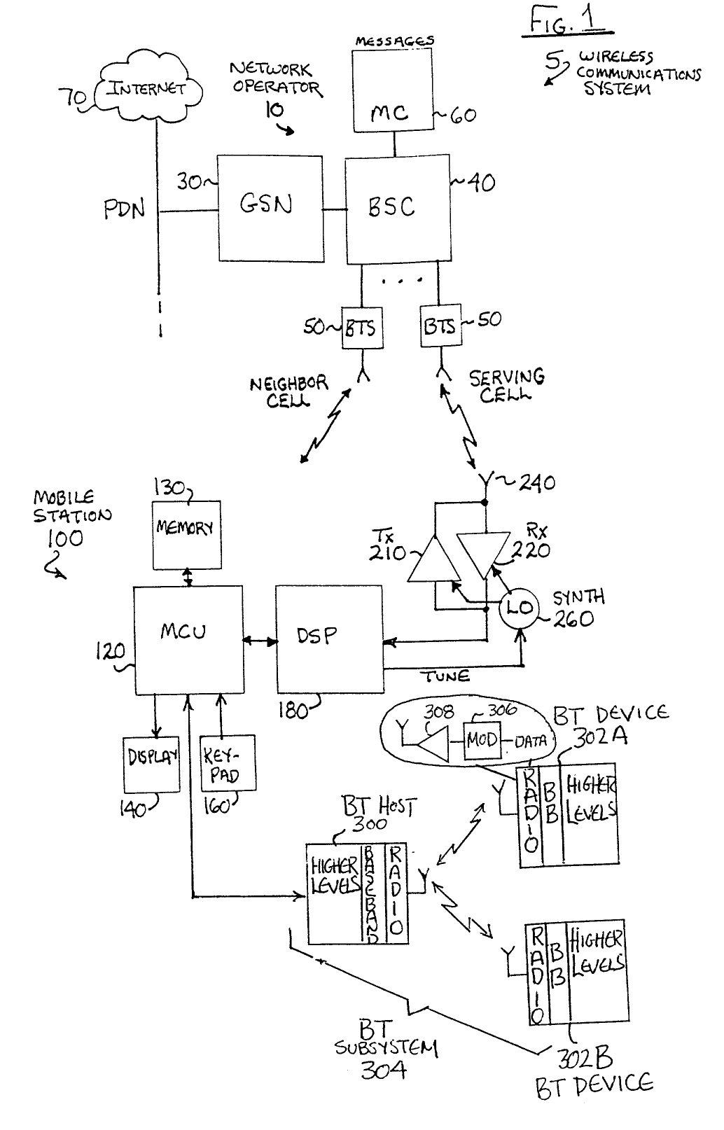

Referring first to FIG. 1, there is illustrated a simplified block diagram of an embodiment of a wireless communications system 5 that is suitable for practicing this invention. The wireless communications system 5 includes at least one mobile station (MS) 100. FIG. 1 also shows an exemplary network operator 10 having, for example, a GPRS Support Node (GSN) 30 for connecting to a telecommunications network, such as a Public Packet Data Network or PDN, at least one base station controller (BSC) 40, and a plurality of base transceiver stations (BTS) 50 that transmit in a forward or downlink direction both physical and logical channels to the mobile station 100 in accordance with a predetermined air interface standard. A reverse or uplink communication path also exists from the mobile station 100 to the network operator 10, which conveys mobile originated access requests and traffic.

The air interface standard can conform to any suitable standard or protocol, and may enable both voice and data traffic, such as data traffic enabling Internet 70 access and web page downloads. In the presently preferred embodiment of this invention the air interface standard could conform to the conventional 800-900 MHz AMPS standard, or to a Code Division Multiple Access (CDMA) standard, such as IS-95 or one based on IS-95. In other embodiments the air interface standard could conform to an 800-900 MHz Time Division Multiple Access (TDMA) air interface, or to one that supports a GSM or an advanced GSM protocol and air interface.

The network operator 10 may also include a suitable type of Message Center (MC) 60 that receives and forwards messages for the mobile stations 100. Other types of messaging service may include Supplementary Data Services and one under currently development and known as Multimedia Messaging Service (MUMS), wherein image messages, video messages, audio messages, text messages, executables and the like, and combinations thereof, can be transferred between the network and the mobile station 100.

The mobile station 100 typically includes a microcontrol unit (MCU) 120 having an output coupled to an input of a display 140 and an input coupled to an output of a keyboard or keypad 160. The mobile station 100 may be a handheld radiotelephone, such as a cellular telephone or a personal communicator. The mobile station 100 could also be contained within a card or module that is connected during use to another device. For example, the mobile station 10 could be contained within a PCMCIA or similar type of card or module that is installed during use within a portable data processor, such as a laptop or notebook computer, or even a computer that is wearable by the user.

The MCU 120 is assumed to include or be coupled to some type of a memory 130, including a read-only memory (ROM) for storing an operating program, as well as a random access memory (RAM) for temporarily storing required data, scratchpad memory, received packet data, packet data to be transmitted, and the like. A separate, removable SIM (not shown) can be provided as well, the SIM storing, for example, a preferred Public Land Mobile Network (PLMN) list and other subscriber-related information. The ROM is assumed, for the purposes of this invention, to store a program enabling the MCU 120 to execute the software routines, layers and protocols required to implement the methods in accordance with these teachings, as well as to provide a suitable user interface (UI), via display 140 and keypad 160, with a user. Although not shown, a microphone and speaker are typically provided for enabling the user to conduct voice calls in a conventional manner.

The mobile station 100 also contains a wireless section that includes or is coupled to a digital signal processor (DSP) 180, or equivalent high speed processor or logic, as well as a wireless transceiver that includes a transmitter 200 and a receiver 220, both of which are coupled to an antenna 240 for communication with the network operator 10. At least one local oscillator (LO) 260, such as a frequency synthesizer, is provided for tuning the transceiver. Data, such as digitized voice and packet data, is transmitted and received through the antenna 240.

It is assumed that the signal is transmitted in the 800 MHz-900 MHz band, and that the third harmonic of the transmitted signal will at least partially overlap the ISM band wherein a co-located Bluetooth (BT) host 300 and associated Bluetooth devices 302A and 302B communicate via the frequency hopping scheme discussed above (in the 2400 MHz to 2500 MHz band). More or less than two Bluetooth devices could be provided. In but one example, BT device 302A is a wireless headset that is worn by the operator, while BT device 302B is a printer. The combination of the BT host 300 and the BT devices 302A, 302B is referred to for convenience as the Bluetooth subsystem 304, and may be considered to be a local area data communications network subsystem, wherein the communicated data can be voice data, computer data, input/output data, or any desired type of data.

A digital data bus 120A is assumed to provide communication between the MCU 120 and the BT host 300, and it is further assumed that the BT host 300 is installed on the same platform as the mobile station 100, or is otherwise operated in close proximity to the mobile station 100. By definition the BT devices 302A, 302B are assumed to be located within some number of meters of the BT host 300. Each of the Bluetooth host 300 and Bluetooth devices 302 includes the above-described Radio and Baseband (BB) layers, and typically also the higher layers that were discussed above.

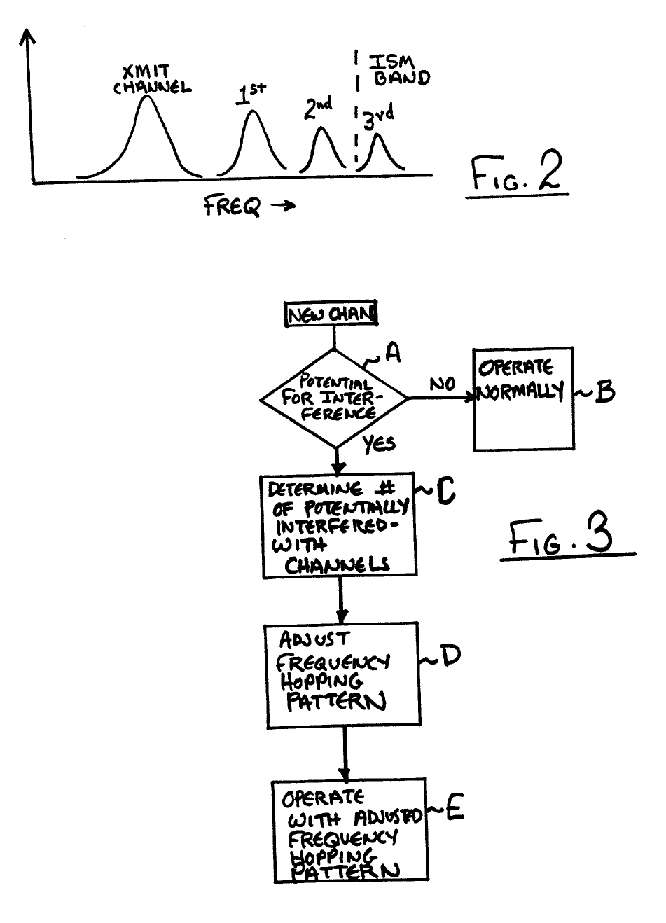

Referring to FIG. 2, it can be seen that for some frequency channels on which the mobile station 100 transmits the 3^{rd} harmonic of the transmitted signal will overlap the ISM band. Within the ISM band the Bluetooth host 300 and Bluetooth devices 302 are communicating using the pseudorandom hopping pattern amongst the 79 channels spaced 1 Mz apart. Depending on the bandwidth of the mobile station 100 transmission (e.g., 30 kHz for AMPS and DAMPS, 5 MHz for CDMA) at least one and possibly four or more of the Bluetooth channels can be interfered with by the 3^{rd} harmonic of the mobile station transmission.

In accordance with a first embodiment of these teachings this problem is overcome by changing or altering the frequency hopping pattern of the Bluetooth host 300 and Bluetooth devices 302 so as to avoid those channels where interference from the mobile station 100 exists.

In accordance with an aspect of these teachings a technique is provided for signaling the required alteration of the frequency hopping pattern from the Bluetooth host 300 to the Bluetooth devices 302A and 302B.

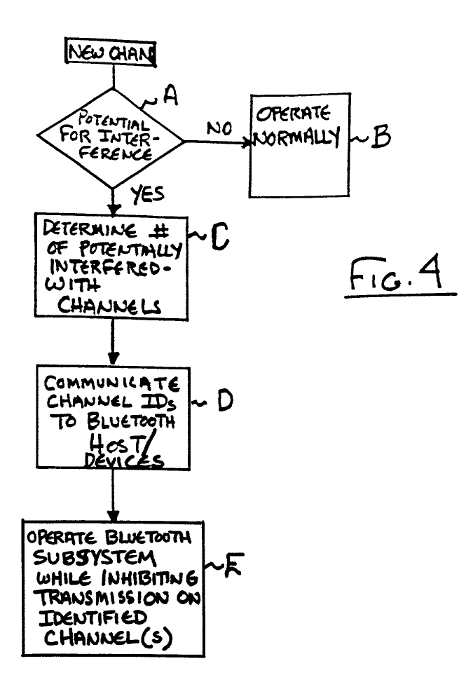

More specifically, the MCU 120 is assumed to have knowledge of both the current transmit channel of the mobile station 100 and the frequency hopping pattern of the Bluetooth subsystem 304. Referring also to FIG. 3, at Step A of the first embodiment the MCU 120 determines, when first coming to a new transmit channel, if there is a possibility that the 3^{rd} harmonic of the signal to be transmitted (or some other known frequency or frequency component) can interfere with the operation of the Bluetooth subsystem 304. If the determination is negative, then operation continues in a normal fashion so as to transmit on the assigned channel (Step B). If the determination at Step A is positive, then at Step C the MCU may make a further determination, based on the bandwidth of the transmission, of how many Bluetooth subsystem 304 channels may be potentially interfered with. Step C is optional, as some predetermined number of channels (including possibly a guard band of channels) may always be identified based on the required mobile station 100 transmit frequency. In any case, at Step D the MCU 120 communicates with the BT host 300, and as a result of the communication the Baseband layer of the Bluetooth protocol stack adjusts the frequency hopping pattern accordingly, and transmits the altered frequency hopping pattern to the Bluetooth devices 302A and 302B using a suitable signaling protocol that is defined for this purpose. At Step E the Bluetooth subsystem 304 continues operation with the modified frequency hopping pattern, and interference from the transmitter 210 of the mobile station 100 is thus avoided as received signals at the co-located Bluetooth host 300 are not interfered with by the transmission from the transmitter 210 of the mobile station 100.

The alteration of the frequency hopping pattern can be done in a number of ways. For example, a block of n contiguous barred channels may identified and removed from the set of 79 channels such that the resulting frequency hopping pattern never encounters the n barred channels. Further by example, the full set of 79 channels may be used by the frequency hopping algorithm, but when one of the n barred channels is selected to be the next channel to hop to, the frequency hop is made instead to another (non-barred) channel. In either example n may have a value in the range of one, such as when the mobile station transmitter 210 operates with a 30 kHz bandwidth, to more than one, such as a value of four or greater when the mobile station transmitter operates with a 5 MHz bandwidth. The end result is that the Bluetooth subsystem 304 does not use a frequency channel that may be experiencing interference from the harmonics or other spurious signals generated by the transmitter 210 of the mobile station 100, and the link quality is not degraded.

In a further embodiment of these teachings the MCU 120 does not communicate with the Bluetooth Host 300 to alter the frequency hopping pattern of the Bluetooth subsystem 304, but instead to inhibit the transmission of data in the Bluetooth subsystem 304 when a hopped-to frequency is determined to be a frequency that may be interfered with because of operation of the mobile station transmitter 210 on the currently specified frequency channel. In this embodiment the transmission of data is preferably also selectively inhibited as a function of a bandwidth of the currently specified frequency channel of the mobile station 100. More specifically, the transmission of data in the Bluetooth subsystem 304 is inhibited for those cases where the currently specified mobile station transmit frequency channel is one having a harmonic frequency that lies in the ISM band. That is, if the hopped-to frequency is one that corresponds to the 3^{rd} harmonic of the transmit frequency, and thus has the potential to be interfered with by the mobile station transmitter 210, then transmission of data within the Bluetooth subsystem 304 is halted or inhibited for the slot duration of the hopped-to frequency channel.

In this embodiment the transmission in the Bluetooth subsystem 304 may be inhibited by turning off a modulator 306 during the slot time of the hopped-to frequency channel, thereby not transmitting data, or the transmission may be inhibited by turning off the RF carrier of the Bluetooth transmitter 308 during the slot time of the hopped-to frequency channel, thereby also not transmitting data. The transmission of data may also be inhibited by simply transmitting random bits, or some predetermined pattern of bits (e.g., all zeroes, all ones, alternating ones and zeroes), instead of the actual data to be transmitted. At the end of the slot time of the hopped-to frequency channel, and when hopping to a next channel (assuming that the next channel is not also potentially interfered with), the transmission of data is resumed, such as by turning on the modulator 306 or the RF carrier of the transmitter 308, or by replacing the random or other bit pattern with actual data, and data transmission to the receiver of the Bluetooth Host 300 located at the mobile station 100 is once more initiated.

As in the embodiment of FIG. 3, and referring now to FIG. 4, the MCU 120 is assumed to have knowledge of both the current transmit channel of the mobile station 100 and the frequency hopping pattern of the Bluetooth subsystem 304. At Step A of this second embodiment the MCU 120 determines, when first coming to a new transmit channel, if there is a possibility that the 3^{rd} harmonic of the signal to be transmitted can interfere with the operation of the Bluetooth subsystem 304. If the determination is negative, then operation continues in a normal fashion so as to transmit on the assigned channel (Step B). If the determination at Step A is positive, then at Step C the MCU may make a further determination, based on the bandwidth of the transmission, of how many Bluetooth subsystem 304 channels may be potentially interfered with. As in the embodiment of FIG. 3, Step C is optional, as some predetermined number of channels (including possibly a guard band of channels) may always be identified based on the required mobile station 100 transmit frequency. At Step D the MCU 120 communicates with the Bluetooth Host 300, and as a result of the communication the Baseband layer of the Bluetooth protocol stack records the Bluetooth frequency channel(s) wherein transmission to the Bluetooth Host 300 is to be avoided, and transmits this information to the Bluetooth devices 302A and 302B using a suitable signaling protocol that is defined for this purpose. At Step E the Bluetooth subsystem 304 continues operation by avoiding transmission of data on the identified frequency channel(s), either by disabling the modulator 306 or the RF carrier of the Bluetooth transmitters 308, or by transmitting bits other than the bits of the actual data. Since the Bluetooth Host 300 has knowledge of on which channel or channels data will not be transmitted, it may disable its receiver for the slot duration, or it may simply ignore the output of the Bluetooth receiver. Thus, interference from the transmitter 210 of the mobile station 100 is avoided, as the received signals at the co-located Bluetooth host 300 are not interfered with by the transmission from the transmitter 210 of the mobile station 100.

In the embodiments of FIGS. 3 and 4, and if the mobile station 100 is changing from a transmit frequency channel that resulted in the Bluetooth subsystem 300 having to alter the frequency hopping pattern or inhibiting data transmission, to a frequency channel that is deemed to be non-interfering, then appropriate signaling is employed to inform the component parts of the Bluetooth subsystem 300 that the previous transmission channel restrictions are removed.

While described in the context of presently preferred embodiments these teachings should not be construed to be limited to only these embodiments. For example, local RF communication schemes other than one based on the Bluetooth technique may be employed. In general, these teachings apply to other types of mobile station 100 air interfaces operating in a first frequency band that has the potential to interfere with an associated short range RF communication system that employs some type of frequency hopping or similar technique for communication within a second frequency band. Also, the described frequency bands and bandwidths are exemplary, and other types of single mode or multi-mode mobile stations may use other frequencies and/or bandwidths. Furthermore, while described in the context of the avoidance of the interference of the third harmonic of the cellular system transmission into the ISM band, depending on the frequency of operation other than the third harmonic may be of concern. In general, these teachings seek to avoid any known frequency or frequency component (spurious or otherwise) of the mobile station 100 transmission that may potentially interfere with one or more frequency channels of the frequency hopping local area communications system, such as the Bluetooth subsystem 300.

What is claimed is:

1. A communication system, comprising:
a mobile station having a transmitter operating on one of a plurality of frequency channels in a first RF frequency band;
an associated local area communication subsystem operating by frequency hopping amongst a plurality of channels in a second RF frequency band; and
a controller for altering a frequency hopping pattern of said local area communication subsystem as a function of a currently specified frequency channel in the first frequency band.

2. A communication system as in claim 1, wherein the frequency hopping pattern is altered if the currently specified frequency channel is one having a known frequency or frequency component that lies in the second frequency band.

3. A communication system as in claim 1, wherein the first frequency band is in the range of about 800 MHz to about 900 MHz, and wherein the second frequency band is in the range of about 2400 MHz to about 2500 MHz.

4. A communication system as in claim 1, wherein the first frequency band is in the range of about 824 MHz to about 891 MHz, and wherein frequency hops occur at 2402+k MHz, where k=0, 1, . . . , 78.

5. A communication system as in claim 1, wherein the frequency hopping pattern is altered by excluding at least one of said plurality of channels.

6. A communication system as in claim 1, wherein the frequency hopping pattern is altered by selecting another channel if an excluded at least one of said plurality of channels is selected to be hopped to.

7. A communication system, comprising:
a mobile station having a transmitter operating on one of a plurality of frequency channels in a first RF frequency band;
an associated local area communication subsystem operating by frequency hopping amongst a plurality of channels in a second RF frequency band; and
a controller for altering a frequency hopping pattern of said local area communication subsystem as a function of a currently specified frequency channel in the first frequency band, and as a function of a bandwidth of the currently specified frequency channel.

8. A communication system as in claim 7, wherein the frequency hopping pattern is altered if the currently specified frequency channel is one having a harmonic frequency that lies in the second frequency band.

9. A communication system as in claim 7, wherein the first frequency band is in the range of about 800 MHz to about 900 MHz, wherein the second frequency band is in the range of about 2400 MHz to about 2500 MHz, and wherein the bandwidth is in the range of about 30 kHz to about 5 MHz.

10. A communication system as in claim 7, wherein the first frequency band is in the range of about 824 MHz to about 891 MHz, wherein frequency hops occur at 2402+k MHz, where k=0, 1, . . . , 78, and wherein the bandwidth is in the range of about 30 kHz to about 5 MHz.

11. A communication system as in claim 7, wherein the frequency hopping pattern is altered by excluding at least one of said plurality of channels if the bandwidth is about 3 kHz, and excluding more than one of said plurality of channels if the bandwidth is about 5 MHz.

12. A communication system as in claim 7, wherein the frequency hopping pattern is altered by selecting another channel if an excluded at least one of said plurality of channels is selected to be hopped to.

13. A method for operating a communication system, comprising:
preparing to operate a mobile station transmitter on one of a plurality of frequency channels in a first RF frequency band;
determining if a harmonic of the frequency channel to be operated has the potential to interfere with communications within an associated local area communication subsystem that operates by frequency hopping amongst a plurality of channels in a second RF frequency band; and
if so, altering a frequency hopping pattern of the local area communication subsystem so as to avoid the interference.

14. A method as in claim 13, wherein the step of determining also considers a bandwidth of the frequency channel to be operated on.

15. A method as in claim 13, wherein the frequency hopping pattern is altered if the frequency channel to be operated on is one having a harmonic frequency that lies in the second frequency band.

16. A method as in claim 13, wherein the first frequency band is in the range of about 800 MHz to about 900 MHz, and wherein the second frequency band is in the range of about 2400 MHz to about 2500 MHz.

17. A method as in claim 13, wherein the first frequency band is in the range of about 824 MHz to about 891 MHz, and wherein frequency hops occur at 2402+k MHz, where k=0, 1, . . . , 78.

18. A method as in claim 13, wherein the frequency hopping pattern is altered by excluding at least one of said plurality of channels.

19. A method as in claim 13, wherein the frequency hopping pattern is altered by selecting another channel if an excluded at least one of said plurality of channels is selected to be hopped to.

20. A method as in claim 14, wherein the frequency hopping pattern is altered by excluding at least one of said plurality of channels if the bandwidth is about 30 kHz, and excluding more than one of said plurality of channels if the bandwidth is about 5 MHz.

21. A communication system, comprising:
a mobile station having a transmitter operating on one of a plurality of frequency channels in a first RF frequency band;
an associated local area communication subsystem operating by frequency hopping amongst a plurality of channels in a second RF frequency band; and
a controller for inhibiting transmission of data in the local area communication subsystem when a hopped-to frequency is determined to be a frequency that may be interfered with because of operation of the mobile station transmitter on a currently specified frequency channel in the first frequency band.

22. A communication system as in claim 21, wherein the transmission is inhibited if the currently specified frequency channel is one having a known frequency or frequency component that lies in the second frequency band.

23. A communication system as in claim 21, wherein the first frequency band is in the range of about 800 MHz to about 900 MHz, and wherein the second frequency band is in the range of about 2400 MHz to about 2500 MHz.

24. A communication system as in claim 21, wherein the first frequency band is in the range of about 824 MHz to about 891 MHz, and wherein frequency hops occur at 2402+k MHz, where k=0, 1, . . . , 78.

25. A communication system as in claim 21, wherein the transmission of data is inhibited by disabling an RF modulator.

26. A communication system as in claim 21, wherein the transmission of data is inhibited by disabling an RF carrier.

27. A communication system as in claim 21, wherein the transmission of data is inhibited by transmitting bits other than bits of data.

28. A communication system as in claim 21, wherein the transmission of data is inhibited also as a function of a bandwidth of the currently specified frequency channel.

29. A communication system as in claim 28, wherein the bandwidth is in the range of about 30 kHz to about 5 MHz.

30. A communication system as in claim 28, wherein the transmission of data is inhibited on at least one of said plurality of channels if the bandwidth is about 30 kHz, and is inhibited on more than one of said plurality of channels if the bandwidth is about 5 MHz.

31. A method for operating a communication system, comprising:
preparing to operate a mobile station transmitter on one of a plurality of frequency channels in a first RF frequency band;
determining if a harmonic of the frequency channel to be operated has the potential to interfere with communications within an associated local area communication subsystem that operates by frequency hopping amongst a plurality of channels in a second RF frequency band; and
if so, inhibiting transmission of data on at least one of said plurality of channels, when hopping to the at least one of said plurality of channels, so as to avoid the interference.

32. A method as in claim 31, wherein the step of determining also considers a bandwidth of the frequency channel to be operated on.

33. A method as in claim 31, wherein the transmission of data is inhibited if the hopped-to frequency channel corresponds to a harmonic frequency of the frequency channel to be operated on.

34. A method as in claim 31, wherein the first frequency band is in the range of about 800 MHz to about 900 MHz, and wherein the second frequency band is in the range of about 2400 MHz to about 2500 MHz.

35. A method as in claim 31, wherein the first frequency band is in the range of about 824 MHz to about 891 MHz, and wherein frequency hops occur at 2402+k MHz, where k=0, 1, . . . , 78.

36. A method as in claim 31, wherein the transmission is inhibited by at least one of disabling an RF modulator, disabling an RF carrier, and transmitting bits other than bits of data.

37. A method as in claim 31, wherein the bandwidth is in the range of about 30 kHz to about 5 MHz.

38. A method as in claim 31, wherein the transmission is inhibited on at least one of said plurality of channels if the bandwidth is about 30 kHz, and is inhibited on more than one of said plurality of channels if the bandwidth is about 5 MHz.

39. A method as in claim 31, wherein the step of inhibiting includes a preliminary step of transmitting information from a local area communications controller that is co-located with the mobile station to at least one remotely located local area communications controller, the transmitted information including information for specifying identities of one or more frequency channels of the plurality of frequency channels over which transmission of data is to be inhibited.
